(19) United States
(12) Patent Application Publication
(10) Pub. No.: US 2024/0272304 A1
(43) Pub. Date: Aug. 15, 2024

(54) Method for Detecting GNSS Spoofing in a GNSS Receiver of a Localization System

(71) Applicant: Robert Bosch GmbH, Stuttgart (DE)

(72) Inventors: Christian Skupin, Garbsen (DE); David Oertel, Hannover (DE)

(21) Appl. No.: 18/569,557

(22) PCT Filed: May 19, 2022
(86) PCT No.: PCT/EP2022/063553

§ 371 Date: Dec. 12, 2023

(30) Foreign Application Priority Data
Jun. 14, 2021 (DE) 10 2021 206 041.2

(51) Int. Cl. G01S 19/21; G01S 19/29

(52) U.S. Cl. CPC G01S 19/215; G01S 19/29

(57) ABSTRACT

A method for detecting GNSS spoofing by way of GNSS receiver of a localization system is disclosed. The GNSS receiver includes an antenna for receiving GNSS signals. The GNSS signals are emitted by at least one GNSS satellite and are received by the GNSS receiver in such a way that each GNSS signal is shifted by a frequency difference. The method includes a) receiving a GNSS signal by way of the antenna, b) measuring the frequency difference between the frequency of the GNSS signal emitted by a GNSS satellite and the frequency of the GNSS signal received by the antenna, c) determining the rate of change of the frequency difference by using motion change information relating to the GNSS receiver, d) checking if the determined rate of change corresponds to a rate of change characteristic of satellite signal reception, and e) detecting GNSS spoofing if the determined rate of change does not match satellite signal reception.

### PRIOR ART

The present invention relates to a method for detecting GNSS spoofing by means of a GNSS receiver of a localization system.

A global navigation satellite system (abbreviation: GNSS) is a system for position determination and navigation on Earth and in the air by receiving navigation satellite signals. Using a localization system with a GNSS receiver, an object equipped with the localization system can be positioned and navigated.

However, nowadays the navigation satellite signals can be falsified without great effort using inexpensive hardware and open-source software, for example, so that the object can be manipulated using the falsified navigation satellite signals. This is known as GNSS spoofing and is particularly important for autonomous driving. This is because autonomous driving places particularly high demands on safety and integrity (or correctness of the location information, e.g. correctness of the accuracy information) in addition to positioning accuracy. The security of GNSS-based positioning is particularly relevant in the context of safety-critical automated driving functions in order to protect positioning from manipulation by falsified navigation satellite signals. Real-time detection of GNSS spoofing is therefore considered particularly necessary for autonomous driving.

With the previous methods, GNSS spoofing is detected, for example
based on the power of navigation satellite signals,
based on encrypted navigation satellite signals,
with the aid of an inertial measurement unit (IMU),
based on the determination of the position of the GNSS receiver by means of an auxiliary signal, or
based on the analysis of the carrier-to-noise values (CNO values) of navigation satellite signals.

However, the use of the above methods is very limited due to the variety of GNSS spoofing methods. This is because a falsified navigation satellite signal can, for example, also have a power value or an encryption like an authentic navigation satellite signal.se a counterfeit navigation satellite signal can, for example,

The present invention describes a new way of detecting GNSS spoofing based on the Doppler effect. This is because fake navigation satellite signals are usually transmitted through one antenna and all come from the same direction, whereas the authentic navigation satellite signals come from different directions due to the distribution and motion of navigation satellites. The entry angles of navigation satellite signals are therefore very difficult to simulate using GNSS spoofing methods. This weakness of GNSS spoofing can be put to good use for its detection.

### DISCLOSURE OF THE INVENTION

Based on this, a particularly advantageous method for detecting GNSS spoofing in a GNSS receiver of a localization system is described here.

This document describes a method for detecting GNSS spoofing by means of GNSS receiver of a localization system, wherein the GNSS receiver comprises an antenna for receiving GNSS signals, and wherein the GNSS signals are emitted by at least one GNSS satellite and are received by the GNSS receiver in such a way that each GNSS signal is shifted by a frequency difference, the method comprising the following steps:
a) receiving a GNSS signal by means of the antenna,
b) measuring the frequency difference between the frequency of the GNSS signal emitted by a GNSS satellite and the frequency of the GNSS signal received by the antenna,
c) determining the rate of change of the frequency difference by using motion change information relating to the GNSS receiver,
d) checking if the determined rate of change corresponds to a rate of change characteristic of satellite signal reception, and
e) detecting GNSS spoofing if the determined rate of change does not match satellite signal reception.

The method described is particularly suitable for autonomous driving. Autonomous driving here refers in particular to the motion of vehicles, mobile robots and driverless transportation systems (e.g. motor vehicles, aircraft, ships) that behave largely autonomously by means of a GNSS receiver and based on global navigation satellite systems (GNSS). It is particularly advantageous if a self-driving motor vehicle with a localization system is equipped with such a GNSS receiver for carrying out the described method.

The global navigation satellite systems are, for example,
NAVSTAR GPS (Global Positioning System) of the United States of America,
GLONASS (global satellite navigation system) of the Russian Federation,
Galileo of the European Union, and
BeiDou of the People's Republic of China.

The GNSS signal here refers in particular to the signal transmitted by a satellite of a Global Navigation Satellite System (GNSS). The reception and evaluation of the GNSS signal is permanently connected to a hardware GNSS receiver.

The term “GNSS spoofing” refers in particular to the transmission of deliberately manipulated GNSS signals in order to manipulate the calculated time and/or location in a GNSS receiver. The GNSS spoofing signal is a decoy signal simulated after the GNSS signal, whose own identity is concealed by a decoy method. The evaluation of the GNSS spoofing signal therefore provides an incorrect positioning.

The physical basis for carrying out the method described is the Doppler effect, which represents the temporal compression or expansion of a signal when the distance between the transmitter and receiver changes during the transmission of the signal. This is because the global navigation satellite system is a moving system with the motion of its satellites and also the GNSS receiver, which is why the received GNSS signal is subject to the Doppler effect due to these motions, so that the emitted GNSS signal is received shifted by the Doppler frequency. In other words, this means that the frequency of the transmitted GNSS signal is different from the frequency of the received GNSS signal, wherein the Doppler frequency corresponds to the frequency difference between the frequency of the transmitted GNSS signal and the frequency of the received GNSS signal. This Doppler frequency also changes with the change in relative motion between the GNSS signal transmitter and the GNSS signal receiver. In addition, the position and motion of a GNSS satellite can be determined by ephemerides, for example, and the motion of the GNSS receiver can be determined by motion sensors, such as inertial measurement units, gyroscopes or steering wheel angle sensors, so that the expected Doppler frequency and its change due to the determinable motion of the GNSS satellite and the GNSS receiver can also be determined. Possible GNSS spoofing is therefore detected if the Doppler frequency and its change do not behave as expected.

In order to detect possible GNSS spoofing, the Doppler frequency described above is measured in step b) after receiving a GNSS signal in step a). In other words, the frequency difference measured in step b) between the frequency of the GNSS signal emitted by a GNSS satellite and the frequency of the GNSS signal received by the antenna is essentially a Doppler frequency which arises due to the relative motion between the GNSS satellite and the GNSS receiver. The frequency difference is referred to below as the Doppler frequency.

In step b), the Doppler frequency can be determined using a frequency locked loop (FLL), for example. Depending on the satellite motion, the received GNSS signal has a satellite-specific Doppler frequency. This depends on whether the GNSS satellite is currently approaching the GNSS receiver or moving away from it. Since the orbits of GNSS satellites are known, the Doppler frequency can be predicted by the GNSS receiver. This checks whether the Doppler frequency is plausible. This can be done with the knowledge of the approximate position of the GNSS receiver (e.g. deviation of the assumed position from the actual position is less than 1 km) and knowledge of the position of the GNSS satellite over time with the aid of e.g. the almanac and/or the ephemerides. Knowing the position and motion of the GNSS satellite in relation to the approximate position of the GNSS receiver allows the expected Doppler frequency to be measured, which results from the relative motion between the GNSS satellite in the sky or in orbit and the GNSS receiver on earth.

In step c), the rate of change of the frequency difference is determined using motion change information of the GNSS receiver. This determines how the change in the Doppler frequency measured in step b) depends on the motion change information of the GNSS receiver. The motion change information describes how the motion of the GNSS receiver changes within a time interval. Such a change in motion can mathematically mean, for example, the 2nd order derivative of the shift vector with respect to time or the 1st order derivative of the shift vector with respect to a steering angle in relation to the direction of motion of the GNSS receiver. The change in motion can, for example, be an accelerated and/or direction-changing motion of the GNSS receiver.

The motion change information in relation to the GNSS receiver is particularly advantageous for protection against GNSS spoofing, because the change in motion of the GNSS receiver is not (or only with difficulty) simulated by the spoofer. This is because it is technically quite difficult for a spoofer to determine the motion of a specifically selected target receiver live in the general case and to incorporate this information appropriately into the spoofed signal.

In step d), it is checked whether the determined rate of change corresponds to a rate of change characteristic of a satellite signal reception.

In GNSS spoofing, the fake GNSS signals are typically emitted from one location. This differs fundamentally from the way in which authentic signals are emitted, as authentic GNSS signals are emitted via satellites, which are distributed approximately evenly in the sky from the receiver's point of view. This is desirable in order to achieve low DOP values and thus higher positioning accuracy through an advantageous satellite geometry. Authentic GNSS signals therefore arrive at the GNSS receiver from different directions. In contrast, GNSS signals spoofed by GNSS spoofing are received from the direction of a radiating antenna. The reception directions of authentic GNSS signals are thus significantly more diverse. The rate of change of the Doppler frequency in the case of GNSS spoofing is therefore different from the authentic case.

The rate of change of the Doppler frequency is mathematically, for example, the first-order derivative of the Doppler frequency with respect to time. The real-time rate of change (actual rate of change) can thus be measured by a control unit according to the signal received. In addition, the satellites of a GNSS only move according to a certain motion pattern, which can be determined in advance. A target rate of change can be measured according to the motion pattern of the satellites.

In step e), GNSS spoofing is detected if the determined actual rate of change does not match the determined target rate of change. In other words, this means that GNSS spoofing is detected if the determined rate of change does not match a satellite signal reception.

The Doppler frequencies of the falsified GNSS signals received can change in approximately the same way when, for example, a motor vehicle equipped with the GNSS receiver accelerates. This is because, as described above, the fake GNSS signals are all received from approximately the same direction under the influence of the GNSS receiver's motion change information and the spoofer does not normally simulate the change in motion of the GNSS receiver. In contrast, the dual frequencies of the authentic GNSS signals change differently due to their different angles of entry.

It is preferable if the frequency difference is determined in step b) and the rate of change of the frequency difference is determined in step c) using an algorithm based on artificial intelligence. It is advantageous if the frequency difference is determined according to the position of the satellites and the GNSS receiver by machine learning, because machine learning has excellent accuracy and continuous automatic improvement potential when determining the frequency difference. It is particularly advantageous if the rate of change of the Doppler frequency is determined by machine learning using the motion change information of the GNSS receiver. Typical Doppler influences can be learned from the motion changes of the GNSS receiver, so a Doppler response detected as atypical when the motion change of the GNSS receiver can indicate a falsified GNSS signal.

It is preferred if, in step b), the frequency difference is measured taking into account the clock error of the GNSS receiver and/or the motion of at least one GNSS satellite.

Positioning and navigation are also based on time synchronization between a GNSS satellite and a GNSS receiver, in that the distance between the GNSS satellite and the GNSS receiver is determined by the transit time of the GNSS signal transmission. However, a GNSS receiver usually uses a quartz clock whose clock error is significantly greater than the clock error of an atomic clock in the GNSS satellite, which can lead to a deviation in the measurement of the expected Doppler frequency of the received GNSS signal. This deviation is taken into account as a disturbance variable. In addition, the characteristics of the receiver clock error must be known and can be measured with sufficient accuracy so that the detection method described here can function robustly from today's perspective. Otherwise, the mean Doppler change rate used here for spoofing detection cannot be distinguishable from a drift of the receiver clock.

Furthermore, the additional deviations of the GNSS satellite orbit and the GNSS satellite clock can affect the accuracy of the measurement of the expected Doppler frequency. It is preferable if the precise ephemerides or clock corrections can be downloaded from the International GNSS Service (IGS), for example, and stored in a database. These are used in particular to correct the satellite clock and orbit.

Here, for example, the GNSS signals received can be processed using artificial intelligence methods, e.g. by means of a neural network (abbreviation: NN). In the NN, the expected Doppler frequencies can be determined and/or processed using the GNSS information stored in a database, such as the precise ephemerides or clock corrections and taking into account the motion information of the GNSS receiver. The motion information can also be measured using an inertial measurement unit (IMU). In addition to the precise ephemerides, it is also conceivable to use the broadcast ephemerides of the GNSS.

It is preferred if in step c) the rate of change of the frequency difference is measured based on an accelerated and/or on a direction-changing motion of the GNSS receiver.

It is particularly preferred if, in step c), the rate of change of the frequency difference is measured at a point in time and/or averaged over a time interval.

It is also preferred if the point in time corresponds to a point in time before or after the motion change of the GNSS receiver and/or the time interval corresponds to the duration of the motion change of the GNSS receiver.

The rate of change of the frequency difference can be measured, for example, before and after an acceleration of the GNSS receiver. The rate of change of the frequency difference can also be measured, for example, when the GNSS receiver is accelerated. If the Doppler frequencies of the received GNSS signals are approximately the same (including the same sign) after subtracting disturbance variables such as the clock error and the motion of the GNSS satellites as well as the deviation of the GNSS satellite orbits, this is probably GNSS spoofing.

The realization can be done e.g. by logging of:
Doppler frequency of the respective GNSS signals received, and
Speed and/or acceleration of the GNSS receiver

The logged values can be evaluated promptly. For example, values before and after acceleration processes are searched for or selected in the logged data and the difference between the Doppler before and after the acceleration process is calculated for the tracked signals.

The rate of change of the frequency difference can also be measured before and after a direction-changing motion of the GNSS receiver. The procedure is analogous to the procedure described above before and after acceleration. For example, a relative and/or an absolute direction of motion can be logged, wherein the relative direction of motion is measured by a gyroscope or a steering wheel angle sensor, for example, and the absolute direction of motion by a compass. The change in the direction of motion is preferably considered if the angle of change is greater than 90° and/or the speed of motion of the GNSS receiver is greater than 10 m/s.

In order to further increase the accuracy, the deviations described above can be taken into account before or after or during the motion change of the GNSS receiver (e.g. Doppler drift due to a change in the satellite position in relation to the receiver position when the receiver motion state does not change and/or due to clock errors). The deviations can be subtracted from the logged Doppler-relevant values at the corresponding relevant points in time.

It is also advantageous if the Doppler frequency is measured and averaged over time during the accelerated and/or direction-changing motion of the GNSS receiver. This allows the noise in the measurements to be reduced.

It is preferred if step a) through step c) are carried out repeatedly several times before step d), at least partially in parallel or successively, and wherein in step a) GNSS signals are received from at least two GNSS satellites.

Each global navigation satellite system has a large number of satellites (e.g. Galileo with 28 satellites, GPS with 24 satellites), which are evenly distributed in the sky or orbit and move according to a predetermined motion pattern. If the localization system receives four GNSS signals from the same GNSS at the same time, direct positioning can be carried out without any further aids. In addition, today's localization system comprises a large number of GNSS receivers, each of which also comprises at least one, e.g. two or three GNSS signal transmission channels. This means that today's localization system is also capable of receiving and processing GNSS signals (simultaneously) from different GNSS.

It is therefore advantageous if the Doppler frequencies of the GNSS signals of different GNSS signals are determined by repeatedly carrying out step a) through step c). It is particularly advantageous if step a) through step c) are carried out simultaneously when the GNSS signals are received from the same GNSS. It is also advantageous if step a) through step c) are carried out one after the other if the GNSS signals are received from different GNSS.

It is preferred if in step d) the GNSS spoofing is detected based on an average rate of change and/or on a variance.

It is particularly preferred if GNSS spoofing is detected in step d) if the average rate of change exceeds a predeterminable first reference value.

It is also preferred if GNSS spoofing is detected in step d) if the variance does not exceed a predeterminable second reference value.

As described above, the authentic GNSS signals come from different directions in the sky, so that the rates of change of the Doppler frequencies of the authentic GNSS signals can be mutually compensated during averaging, and so that the average rate of change of the Doppler frequencies of the authentic GNSS signals has a very small value close to zero.

In contrast, the falsified GNSS signals come from the same direction, so that the rates of change of the Doppler frequencies of the falsified GNSS signals behave in the same way and cannot be mutually compensated during averaging, and so that the average rate of change of the Doppler frequencies of the falsified GNSS signals has a relatively large value, which is significantly greater than zero.

It is advantageous if a first reference value is determined in advance as a threshold value. If the average rate of change exceeds the first reference value, this excess indicates GNSS spoofing. It is also advantageous if the first reference value is determined as a function of the change in speed of the GNSS receiver before and after its acceleration.

Analogous to the average rate of change, GNSS spoofing can also be detected by determining the variance. The variance corresponds to the mean square deviation of the rates of change of the Doppler frequencies of the GNSS signals from their average rate of change. If the variance has a very small value, e.g. close to zero, this means that the GNSS signals are coming from the same direction and GNSS spoofing is therefore detected. This means that possible GNSS spoofing is detected if, for example, the variance does not increase with the acceleration of the GNSS receiver and does not exceed the threshold value.

It is advantageous if a second reference value is determined in advance as a threshold value. If the variance does not exceed the second reference value, it shows GNSS spoofing. It is also advantageous if the second reference value is determined as a function of the change in speed of the GNSS receiver before and after its acceleration.

It is particularly advantageous if GNSS spoofing is detected in step d) if the quotient of the average rate of change to the variance exceeds a third predeterminable reference value.

The method described can also be used to track the approximate position of the spoofer. The position of the spoofer can be narrowed down using crowd sourcing in the form of appropriately merged data in a server system or through motor vehicle cooperation and with the aid of the direction of travel of the motor vehicle (e.g. from compass and longitudinal acceleration). If a significant similar change in the Doppler frequency is detected for several received GNSS signals from different satellites when the GNSS receiver changes motion, the direction of reception of the falsified GNSS signal can be determined from the direction of acceleration of the GNSS receiver and the sign of the Doppler frequency. If the effect on the Doppler frequency change is measured at different positions, the position of the spoofer can be narrowed down.

It is preferred if a computer program is used to carry out a method described here. In other words, this relates in particular to a computer program (product) comprising commands which, when the program is executed by a computer, prompt said computer to perform a method described here.

It is particularly preferred if a machine-readable storage medium is used, on which the computer program proposed here is stored. Conventionally, the machine-readable storage medium is a computer-readable data medium.

It is also preferred if the localization system for a vehicle is configured to perform a method described here.

The method presented here and the technical environment are explained in more detail below using the FIGURE. Schematically shown are:

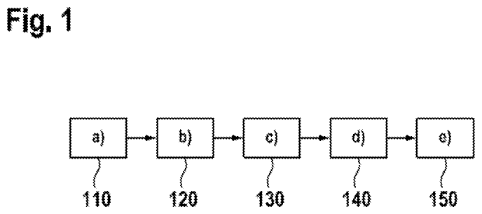

FIG. 1 shows a sequence of a method presented here for detecting GNSS spoofing in a GNSS receiver of a localization system during a regular operating sequence.

FIG. 1 schematically shows a sequence of a method presented here for detecting GNSS spoofing in a GNSS receiver of a localization system during a regular operating sequence. The illustrated sequence of the method steps a), b), c), d), and e) with the blocks 110, 120, 130, 140, and 150 is merely exemplary. A GNSS signal is received by the antenna in block 110. In block 120, the frequency difference between the frequency of the GNSS signal emitted by a GNSS satellite and the frequency of the GNSS signal received by the antenna is measured. In block 130, the rate of change of the frequency difference is determined using motion change information from the GNSS receiver. In block 140, a check is performed to determine whether the determined rate of change corresponds to a rate of change characteristic of satellite signal reception. In block 150, GNSS spoofing is detected if the determined rate of change does not match a satellite signal reception.

In particular, the method steps a) through c) for determining the rate of change of the frequency difference of several different GNSS signals can run at least several times, partially in parallel or simultaneously.

1. A method for detecting GNSS spoofing by way of GNSS receiver of a localization system, wherein the GNSS receiver comprises an antenna for receiving GNSS signals, and wherein the GNSS signals are emitted by at least one GNSS satellite and are received by the GNSS receiver in such a way that each GNSS signal is shifted by a frequency difference, the method comprising:
a) receiving a GNSS signal by way of the antenna,
b) measuring the frequency difference between the frequency of the GNSS signal emitted by a GNSS satellite and the frequency of the GNSS signal received by the antenna,
c) determining the rate of change of the frequency difference by using motion change information relating to the GNSS receiver,
d) checking if the determined rate of change corresponds to a rate of change characteristic of satellite signal reception, and
e) detecting GNSS spoofing if the determined rate of change does not match satellite signal reception.

2. The method according to claim 1, wherein:
at least one step of step b) through step e) is determined using an algorithm based on artificial intelligence.

3. The method according to claim 1, wherein:
in step b) the frequency difference is measured taking into account the clock error of the GNSS receiver and/or the motion of the at least one GNSS satellite.

4. The method according to claim 1, wherein:
in step c) the rate of change of the frequency difference is measured based on an accelerated and/or on a direction-changing motion of the GNSS receiver.

5. The method according to claim 1, wherein:
in step c) the rate of change of the frequency difference is measured at a point in time and/or averaged over a time interval.

6. The method according to claim 5, wherein the time corresponds to a time before or after the motion change of the GNSS receiver and/or the time interval corresponds to the duration of the motion change of the GNSS receiver.

7. The method according to claim 1, wherein:
step a) through step c) are carried out repeatedly several times before step d), at least partially in parallel or successively, and
in step a) GNSS signals are received from at least two GNSS satellites.

8. The method according to claim 7, wherein:
in step d) the GNSS spoofing is detected based on an average rate of change and/or on a variance.

9. The method according to claim 8, wherein;
in step d) GNSS spoofing is detected if the average rate of change exceeds a predeterminable first reference value.

10. The method according to claim 8, wherein:
in step d) GNSS spoofing is detected if the variance does not exceed a predeterminable second reference value.

11. The method according to claim 8, wherein:
in step d) GNSS spoofing is detected if the quotient of the average rate of change to the variance exceeds a third predeterminable reference value.

12. A computer program for performing a method according to claim 1.

13. A machine-readable storage medium on which the computer program according to claim 12 is stored.

14. A localization system for a vehicle which is configured to perform a method according to claim 1.
